(19) United States
(12) Patent Application Publication
(10) Pub. No.: US 2018/0077356 A1
(43) Pub. Date: Mar. 15, 2018

(54) SYSTEM AND METHOD FOR REMOTELY ASSISTED CAMERA ORIENTATION

(71) Applicant: PROJECT RAY LTD., Yokneam (IL)

(72) Inventors: BOAZ ZILBERMAN, RAMAT HASHARON (IL); MICHAEL VAKULENKO, ZICHRON YAAKOV (IL); NIMROD SANDLERMAN, RAMAT GAN (IL)

(21) Appl. No.: 15/700,202

(22) Filed: Sep. 11, 2017

Related U.S. Application Data
(60) Provisional application No. 62/394,766, filed on Sep. 15, 2016.

(51) Int. Cl. H04N 5/232; H04N 7/18; G06F 17/30; G06N 99/00

(52) U.S. Cl. CPC H04N 5/23296; H04N 5/23206; G06N 99/005; H04N 5/23293; G06F 17/30247; H04N 7/188

(57) ABSTRACT

A system for remotely orienting a manually operated imaging device such as a camera performing steps such as capturing at least one image by an imaging device operated by a first user, communicating the image to a viewing station operated by a second user, receiving from the second user an indication of at least one point of interest associated with the image, communicating the point of interest to a computing device associated with the imaging device, converting the point of interest into a measure of required orientation of the imaging device, measuring current imaging device orientation to form current orientation, computing difference between the current orientation and the required orientation, converting the difference into a user-perceptive cue, providing the cue to the first user, repeating such steps until the difference reduces below a predefined threshold, and triggering image capture by the imaging device.

### CROSS-REFERENCE TO RELATED APPLICATIONS

This application claims priority from U.S. Provisional Patent Application Ser. No. 62/394,766, filed Sep. 15, 2016, titled System and Method for Remotely Assisted Camera Orientation, which is incorporated herein by reference.

### FIELD

The method and apparatus disclosed herein are related to the field of communicating imaging, and, more particularly, but not exclusively to systems and methods enabling a remote user to orient a manually operated camera.

### BACKGROUND

Handheld cameras such as smartphone cameras, and wearable cameras wrist-mounted or head mounted are very popular. Streaming imaging content captured by such cameras is also developing fast. Therefore, a remote user viewing in real-time imaging content captured by a manually operated camera is evidently useful. One or more remote users looking at captured pictures may see object of particular interest or importance that the person operating the camera may not see. The person operating the camera may not see such objects because he or she have a different interest, or because he or she does not see the pictures captured by the camera. A special case is when the person operating the camera is visually impaired. The remote user may want the camera to be oriented at the object of interest, however, as the camera is manually operated, the remote user has to manually instruct the person operating the camera where to point the camera. Communication verbal instruction even with training is slow and inaccurate. There is thus a widely recognized need for, and it would be highly advantageous to have, a system and method for remotely orienting a manually operated camera, devoid of the above limitations.

### SUMMARY

According to one exemplary embodiment there is provided a method, a device, and a computer program for remotely orienting a manually operated imaging device such as a camera to perform steps such as: capturing at least one image by an imaging device operated by a first user, communicating the image to a remote station, processing, in said remote station, an indication of at least one point of interest associated with the image, communicating the point of interest to a computing device associated with the imaging device, converting the point of interest into a measure of required orientation of the imaging device, measuring current imaging device orientation to form current orientation, computing difference between the current orientation and the required orientation, converting the difference into a user-perceptive cue, providing the cue to the first user, repeating such steps until the difference reduces below a predefined threshold, and triggering image capture by the imaging device.

According to another exemplary embodiment there is provided a method, a device, and a computer program for remotely orienting a manually operated imaging device such as a camera where the point of interest is at least one of: inside the image and external to the image.

According to yet another exemplary embodiment there is provided a method, a device, and a computer program for remotely orienting a manually operated imaging device such as a camera where the point of interest includes an area.

According to still another exemplary embodiment there is provided a method, a device, and a computer program for remotely orienting a manually operated imaging device such as a camera where the area is at least one of: entirely within the image, partially external to the image, and entirely external to the image.

Further according to another exemplary embodiment there is provided a method, a device, and a computer program for remotely orienting a manually operated imaging device such as a camera where the step e is executed by the remote station.

Still further according to another exemplary embodiment there is provided a method, a device, and a computer program for remotely orienting a manually operated imaging device such as a camera where the difference is a measure of at least one of: a planar angle, a solid angle, and a pair of Cartesian angles.

Yet further according to another exemplary embodiment there is provided a method, a device, and a computer program for remotely orienting a manually operated imaging device such as a camera where the cue includes a pair of cues each associated with one of the pair of Cartesian angles.

Even further according to another exemplary embodiment there is provided a method, a device, and a computer program for remotely orienting a manually operated imaging device such as a camera where the cue includes at least one of an audio signal, a visual signal, and a tactile signal.

Also, according to yet another exemplary embodiment there is provided a method, a device, and a computer program for remotely orienting a manually operated imaging device such as a camera where cue includes at least one magnitude associated with the difference in at least one of a linear and a non-linear manner.

Additionally, according to still another exemplary embodiment there is provided a method, a device, and a computer program for remotely orienting a manually operated imaging device such as a camera where the magnitude includes pitch of an audio signal.

Further according to another exemplary embodiment there is provided a method, a device, and a computer program for remotely orienting a manually operated imaging device such as a camera where the tactile signal includes four tactile signals respectively associated with up, down, left and right difference between the current orientation and the required orientation.

Yet further according to another exemplary embodiment there is provided a method, a device, and a computer program for remotely orienting a manually operated imaging device such as a camera where the cue includes a pulsed signal and where repetition rate of the pulsed signal is associated with the difference between the current orientation and the required orientation.

Still further according to another exemplary embodiment there is provided a method, a device, and a computer program for remotely orienting a manually operated imaging device further receiving from the second user an indication of at least one second point of interest while providing the cue to the first user with respect to a previously provided point of interest.

Even further according to another exemplary embodiment there is provided a method, a device, and a computer program for remotely orienting a manually operated imaging device where the step of processing an indication additionally includes receiving the indication of at least one point of interest from a second user operating the remote station.

Additionally, according to another exemplary embodiment the remote station comprises a software program to determine said point of interest.

According to yet another exemplary embodiment the software program includes artificial intelligence, and/or big-data analysis, and/or machine learning.

According to yet another exemplary embodiment the artificial intelligence, and/or big-data analysis, and/or machine learning computes correlations between the captured image and at least one of: a database of sceneries, and a database of scenarios; and additionally provides least one of: determine the point of interest according to at least one correlation, determine target information and/or point of interest according a first user preference and/or a second user preference associated with the correlation, and determine a cue according to a first user preference associated with a correlation.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments of the invention are described herein, by way of example only, with reference to the accompanying drawings. With specific reference now to the drawings in detail, it is stressed that the particulars shown are by way of example and for purposes of illustrative discussion of the embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified is a simplified illustration of a remote camera orientation system;

FIG. 2 is a simplified block diagram of a computing system;

FIG. 3 is a simplified illustration of a communication channel for communication panorama imaging;

FIG. 4A, FIG. 4B and FIG. 4C are simplified illustrations of a plurality of images of an object, or view;

FIG. 5 is a simplified illustration of a panorama image;

FIG. 6 is a simplified illustration of a combined image made of a plurality of images having a shared feature;

FIG. 7 is a simplified illustration of local camera providing a visual cue;

FIG. 8 which is a simplified illustration of a local camera providing a tactile cue;

FIGS. 9A, 9B, and 9C taken together are a simplified flow-chart of remote orientation software;

FIG. 10 is a block diagram of remote camera orientation system;

FIG. 11 is a simplified flow-chart of a session recording process;

FIG. 12 is a simplified flow-chart of a data scanning process; and

FIG. 13 is a simplified flow-chart of an automatic guiding process.

### DETAILED DESCRIPTION

Embodiments of the invention include systems and methods for remotely orienting a manually operated camera. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method enabling a first user to remotely orienting a camera operated by a second user without resorting to verbal communication.

It is appreciated that this situation is entirely different from the common situation where a remote user directly controls a remotely operated camera. In the common situation, the local camera has provisions enabling a remote user to take control of the camera itself. In the present situation the remote user does not have direct control over the camera. Instead, the camera is controlled by a local user. However, the local user may not see in real-time (or at all) the pictures as captured by the camera.

Therefore, the remote user has to guide the local user where to point the camera. The remote user may guide the local user in real-time, by watching the images captured by the camera. These images may be still pictures, video imaging, 3D imaging, thermal imaging, etc.

Alternatively, the remote user may instruct the system to guide the local user automatically, for example by indicating a particular point of area of interest. This enables the remote user to prepare more points of interest while the local user is capturing a previously indicated point of interest.

In both alternatives, the system enables the remote user to guide the local user using one or more humanly perceptive cues other than directly speaking to the local user. The cue indicates to the local user where to move the camera, and/or the difference between the current camera orientation (direction) and the required orientation. The cue may provide guidance in a single dimension (e.g., left-right), and/or in a two dimensions (e.g., left-right and up-down), or three dimensions (e.g., left-right, up-down, and roll).

It is appreciated that present embodiments include a remote user indicating to a system a point or area of interest and the system automatically guiding a local user to manually point a camera to the indicated point or area of interest. While the system nay include the camera, and while the camera may be providing guiding cues to the local user, the camera orientation is controlled by the local user and not by the system directly.

It is appreciated that non-verbal guiding cues may resolve language problems, for example, when the local user is a tourist, and the local user and the remote user do not speak a common language.

In this context, the term image in may refer to any type or technology for creating an imagery data, such as photography, still photography, video photography, stereo-photography, three-dimensional (3D) imaging, thermal or infra-red (IR) imaging, etc. In this context any such image may be captured, or obtained or photographed.

The term camera in this context refers to a device of any type or technology for creating one or more images or imagery data such as described herein, including any combination of imaging type or technology, etc.

The term local camera refers to a camera obtaining images (or imaging data) in a first place and the terms remote user and remote system or remote station refer to a user and/or a system or station for viewing or analyzing the images obtained by the local camera in a second location, where the second location is remote from the first location. The term location may refer to a geographical place or a logical location within a communication network.

The term remote in this context may refer to the local camera and the remote station being connected by a limited-bandwidth network. For this matter the local camera and the remote station may be connected by a limited-bandwidth short-range network such as Bluetooth. The term limited-bandwidth may refer to any network, or communication technology, or situation, where the available bandwidth is insufficient for communicating the high-resolution images, as obtained, in their entirety, and in real-time or sufficiently fast. In other words, limited-bandwidth may mean that the resolution of the images obtained by the local camera should be reduced before they are communicated to the remote station in order to achieve low-latency.

The term server or communication server refers to any type of computing machine connected to a communication network to enabling communication between one or more cameras (e.g., a local camera) and one or more remote users and/or remote systems.

The term network or communication network refers to any type of communication medium, including but not limited to, a fixed (wire, cable) network, a wireless network, and/or a satellite network, a wide area network (WAN) fixed or wireless, including various types of cellular networks, a local area network (LAN) fixed or wireless, and a personal area network (PAN) fixes or wireless, and any combination thereof.

The term panorama or panorama image refers to an assembly of a plurality, or collection, or sequence, of images (source images) arranged to form an image larger than any of the source images making the panorama. The term particular image or source image may refer to any single image of the plurality, or collection, or sequence of images from which the panorama image is made of.

The term panorama image may therefore include a panorama image assembled from images of the same type and/or technology, as well as a panorama image assembled from images of the different types and/or technologies.

The term register, registration, or registering refers to the action of locating particular features within the overlapping parts of two or more images, correlating the features, and arranging the images so that the same features of different images fit one over the other to create a consistent and/or continuous image, namely, the panorama.

The term panning or scrolling refers to the ability of a user to select and/or view a particular part of the panorama image. The action of panning or scrolling is therefore independent of the form-factor, or field-of-view of any particular image from which the panorama image is made of A user can therefore select and/or view a particular part of the panorama image made of two or more particular images, or parts of two or more particular images.

In this respect, a panorama image may use a sequence of video frames to create a panorama picture and a user may then pan or scroll within the panorama image as a large still picture, irrespective of the time sequence in which the video frames were taken.

The term resolution herein, such as in high-resolution, low-resolution, higher-resolution, intermediate-resolution, etc., may refer to any aspect related to the amount of information associated to any type of image. Such aspects may be, for example:
Spatial resolution, or granularity, represented, for example, as pixel density or the number of pixels per area unit (e.g., square inch or square centimeter).
Temporal resolution, represented, for example, the number of images per second, or as frame-rate.
Color resolution or color depth, or gray level, or intensity, or contrast, represented, for example, as the number of bits per pixel.
Compression level or type, including, for example, the amount of data loss due to compression. Data loss may represent any of the resolution types described herein, such as spatial, temporal and color resolution.
Any combination thereof.

The term resolution herein may also be known as definition, such as in high-definition, low-definition, higher-definition, intermediate-definition, etc.

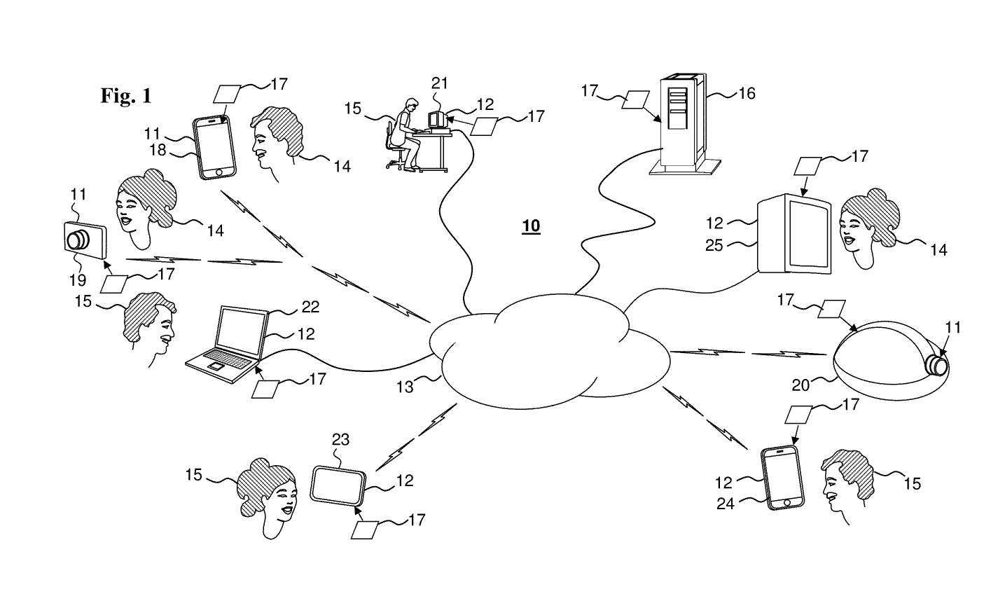

Reference is now made to FIG. 1, which is a simplified illustration of a remote camera orientation system 10, according to one exemplary embodiment.

As shown in FIG. 1, remote camera orientation system 10 may include at least one local camera 11 in a first location, and at least one remote viewing station 12 in a second location. A communication network 13 connects between local camera 11 and the remote viewing station 12. Camera 11 may be operated by a first, local, user 14, while remote viewing station 12 may be operated by a second, remote, user 15. Alternatively or additionally, remote viewing station 12 may be operated by, or implemented as, a computing machine 16 such as a server, which may be named herein imaging server 16. The remote viewing station 12 and/or the imaging server 16 may be also referred to as a remote station.

Local camera 11 may include remote orientation software 17 or a part of remote orientation software 17. Remote viewing station 12 may include remote orientation software 17 or a part of remote orientation software 17. Imaging server 16 may include remote orientation software 17 or a part of remote orientation software 17. Typically, remote orientation software 17 is divided into two parts, a first part executed by remote viewing station 12 or by a device associated with remote viewing station 12, such as imaging server 16, and a second part executed by local camera 11, or by a device associated with local camera 11, such as a mobile computing device, such as a smartphone.

Camera 11 may include an imaging device capable of providing still pictures, video streams, three-dimensional (3D) imaging, infra-red imaging (or thermal radiation imaging), stereoscopic imaging, etc. and combinations thereof. Camera 11 can be part of a mobile computing device such as a smartphone (18). Camera 11 may be hand operated (19) or head mounted (or helmet mounted 20), or mounted on any type of mobile or portable device.

Remote camera orientation system 10 may also include, or use a panorama processing system. The panorama processing system enables the remote viewing station 12 to create in real-time, or near real-time, an accurate panorama image from a plurality of partially overlapping low-resolution images received from local camera 11. More information regarding possible processes and/or embodiments of a panorama processing system may be found in U.S. Provisional Patent Application No. 62/299,177, titled System and method for automatic remote assembly of partially overlapping images, L filed Feb. 24, 2016.

Panorama processing system may include or use a remote resolution system enabling the remote viewing station 12 to request and/or receive from local camera 11 high-resolution (or higher-resolution) versions of selected portions of the low-resolution images. This, for example, enables remote viewing station 12 to create in real-time, or near real-time, an accurate panorama image from the plurality of low-resolution images received from local camera 11. More information regarding possible processes and/or embodiments of a remote resolution system may be found in U.S. Provisional Patent Application No. 62/276,871, titled Remotely Controlled Communicated Image Resolution, filed Jan. 10, 2016.

Remote viewing station 12 may be any computing device such as a desktop computer 21, a laptop computer 22, a tablet or PDA 23, a smartphone 24, a monitor 25 (such as a television set), etc. Remote viewing station 12 may include a (screen) display for use by a remote second user 15. Each remote viewing station 12 may include a remote-resolution remote-imaging module.

Communication network 13 may be any type of network, and/or any number of networks, and/or any combination of networks and/or network types, etc.

Remote camera-orientation system 10 is configured to enable a remote user such as user 15 of a remote viewing station 12 to select a point or an area associated with an image received from local camera 11 for which more information is required. The remote camera-orientation system 10 then directs user 14 operating the local camera 11 to orient local camera 11 in the direction that captures the point or area selected by user 15.

It is appreciated that remote camera-orientation system 10 enables this process in real-time or near-real-time. However, remote camera-orientation system 10 enables this process in off-line or asynchronously, in the sense that once user 15 has selected the required point or area, user 15 needs not be involved in the remote camera orientation process. This is particularly useful with panorama imaging where the area of the panorama image is much larger than the area captured by local camera 11 in a single image capture.

However, remote camera-orientation system 10 may operate on the basis of any imaging technology, and the use of a panorama image is not mandatory. Similarly the use of a remote resolution system is not mandatory either.

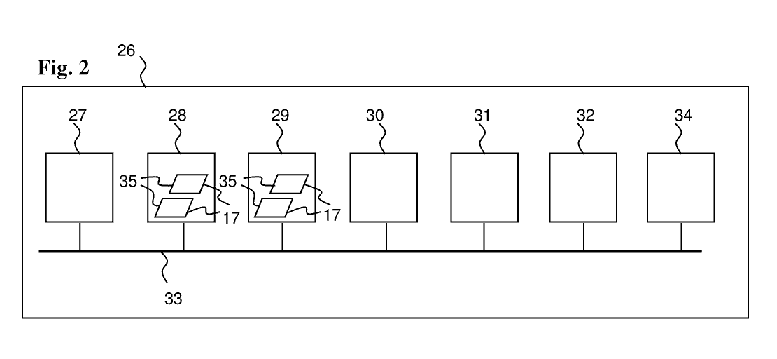

Reference is now made to FIG. 2, which is a simplified block diagram of a computing system 26, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 26 is a block diagram of a computing system, or device, 26, used for implementing a camera 11 (or a computing device hosting camera 11 such as a smartphone), and/or a remote viewing station 12 (or a computing device hosting remote viewing station 12), and/or an imaging server 16 (or a computing device hosting imaging server 16). The term computing system or computing device refers to any type or combination of computing devices, or computing-related units, including, but not limited to, a processing device, a memory device, a storage device, and/or a communication device.

As shown in FIG. 2, computing system 26 may include at least one processor unit 27, one or more memory units 28 (e.g., random access memory (RAM), a non-volatile memory such as a Flash memory, etc.), one or more storage units 29 (e.g. including a hard disk drive and/or a removable storage drive, representing a floppy disk drive, a magnetic tape drive, a compact disk drive, a flash memory device, etc.). Computing system 26 may also include one or more communication units 30, one or more graphic processors 31 and displays 32, and one or more communication buses 33 connecting the above units.

In the form of camera 11, computing system 26 may also include an imaging sensor 34 configured to create a still picture, a sequence of still pictures, a video clip or stream, a 3D image, a thermal (e.g., IR) image, stereo-photography, and/or any other type of imaging data and combinations thereof.

Computing system 26 may also include one or more computer programs 35, or computer control logic algorithms, which may be stored in any of the memory units 28 and/or storage units 29. Such computer programs, when executed, enable computing system 26 to perform various functions (e.g. as set forth in the context of FIG. 1, etc.). Memory units 28 and/or storage units 29 and/or any other storage are possible examples of tangible computer-readable media. Particularly, computer programs 35 may include remote orientation software 17 or a part of remote orientation software 17.

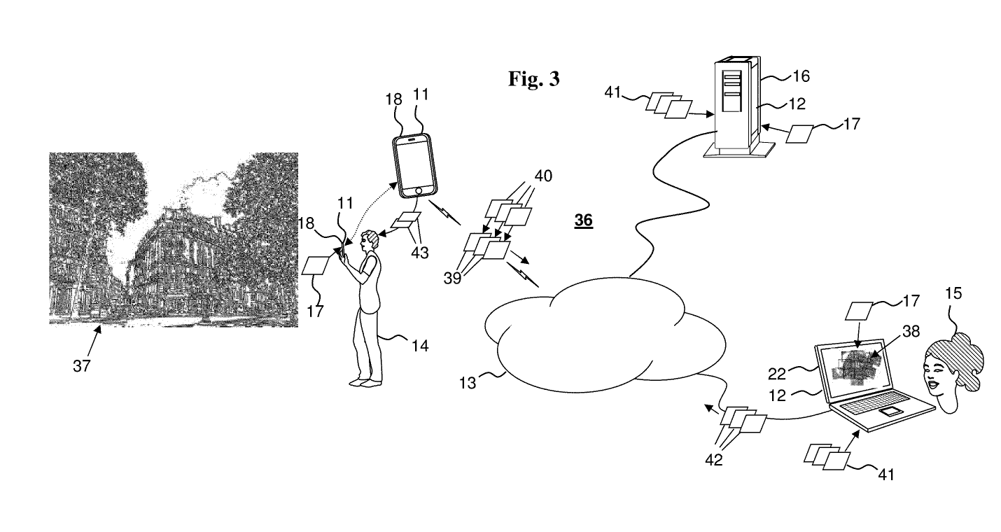

Reference is now made to FIG. 3, which is a simplified illustration of a communication channel 36 for communication panorama imaging, according to one exemplary embodiment. As an option, the illustration of FIG. 3 may be viewed in the context of the details of the previous Figures. Of course, however, the illustration of FIG. 3 may be viewed in the context of any desired environment. Further, the aforementioned definitions may equally apply to the description below.

As shown in FIG. 3, communication channel 36 may include a camera 11 typically operated by a first, local, user 14 and a remote viewing station 12, typically operated by a second, remote, user 15. Camera 11 and remote viewing station 12 typically communicate over communication network 13. Communication channel 36 may also include imaging server 16. Camera 11, and/or remote viewing station 12, and/or imaging server 16 may include computer programs 35, which may include remote orientation software 17 or a part of remote orientation software 17.

As shown in FIG. 3, user 14 may be located in a first place photographing surroundings 37, which may be outdoors, as shown in FIG. 3, or indoors. User 15 may be located remotely, in a second place, watching one or more images captured by camera 11 and transmitted by camera 11 to remote viewing station 12. In the example shown in FIG. 3 viewing station 12 displays to user 15 a panorama image 38 created from images taken by camera 11 operated by user 14.

As an example user 14 may be a visually impaired person out in the street, in a mall, or in an office building and have orientation problems. User 14 may call for assistance of a particular user 15, who may be a relative, or may call a help desk which may assign an attendant of a plurality of attendants currently available. As shown and described with reference to FIG. 1, user 15 may be using a desktop computer with a large display, or a laptop computer, or a tablet, or a smartphone, etc.

As another example of the situation shown and described with reference to FIG. 3, user 14 may be a tourist traveling in a foreign country and being unable to read signs and orient himself appropriately. As another example, user 14 may be a first responder or a member of an emergency force. For example, user 14 may stick his hand with camera 11 into a space and scan it so that another member of the group may view the scanned imagery. For this matter, users 14 and 15 may be co-located.

A session between a first, local, user 14 and a second, remote, user 15 may start by the first user 14 calling the second user 15 requesting help, for example, navigating or orienting (finding the appropriate direction). In the session, the first user 14 operates the camera 11 and the second user 15 views the images provided by the camera and directs the first user 14.

A typical reason for the first user to request the assistance of the second user is a difficulty seeing, and particularly a difficulty seeing the image taken by the camera. Such reason is that the first user is visually impaired, or being temporarily unable to see. The camera display may be broken or stained. The first user s glasses, or a helmet protective glass, may be broken or stained. The user may hold the camera with the camera display turned away or with the line of sight blocked (e.g., around a corner). Therefore, the first user does not see the image taken by the camera, and furthermore, the first user does not know where exactly the camera is directed. Therefore, the images taken by the camera 11 operated by the first user 14 are quite random.

The first user 14 may call the second user 15 directly, for example by providing camera 11 with a network identification of the second user 15 or the remote viewing station 12. Alternatively, the first user 14 may request help and the distribution server (not shown) may select and connect the second user 15 (or the remote viewing station 12). Alternatively, the second user 15, or the distribution server may determine that the first user 14 needs help and initiate the session. Unless specified explicitly, a reference to a second user 15 or a remote viewing station 12 refers to an imaging server 16 too.

Typically, first user 14 operating camera 11, may take a plurality of high-resolution images, such as a sequence of still pictures or a stream of video frames. Alternatively, or additionally, first 14 may operate two or more imaging devices, which may be embedded within a single camera 11, or implemented as two or more devices, all referenced herein as camera 11. Alternatively, or additionally, a plurality of first users 14 operating a plurality of cameras 11 may take a plurality of images.

Camera 11 may take a plurality of high-resolution images, store the high-resolution images internally, convert the high-resolution images into low-resolution images 39, and transmit the plurality of low-resolution images 39 to viewing station 12, typically by using remote orientation software 17 or a part of remote orientation software 17 embedded in cameras 11. Each of images 39 may include, or be accompanied by, capture data 40.

Capture data 40 may include information about the image such as the position (location) of the camera when the particular image 39 has been captured, the orientation of the camera, optical data such as type of lens, shutter speed, iris opening, etc. Camera position (location) may include GPS (global positioning system). Camera orientation may include three-dimensional, or six degrees of freedom information, regarding the direction in which the camera is oriented. Such information may be measured using an accelerometer, and/or a compass, and/or a gyro. Particularly, camera orientation data may include the angle between the camera and the gravity vector.

The plurality of imaging devices herein may include imaging devices of different types, or technology, producing images of different types, or technologies, as disclosed above (e.g., still, photography, video, stereo-photography, 3D imaging, thermal imaging, etc.).

Alternatively, or additionally, the plurality of images is transmitted by cameras 11 to an imaging server 16 that may then transmit images to viewing station 12 (or rather, viewing station 12 may retrieve images from imaging server 16).

Viewing station 12 and/or imaging server 16, may then create a one or more panorama images 41 from any subset plurality of images of the plurality of low-resolution images 39. Viewing station 12 may retrieve panorama images 41 from imaging server 16.

Remote user 15, using viewing station 12, may then indicate a point or an area associated with panorama image 38, for which he or she requires capturing one or more images by camera 11. Remote viewing station 12, may then send one or more image capture indication data 42 to camera 11. Camera 11 may then provide one or more cues 43 to local user 14, the cues guiding user 14 to orient camera 11 in the direction required to capture the image (or images) as indicated by remote user 15, and to capture the desired images.

Thereafter, camera 11 may send (low-resolution) images 39 (with their respective capture data 40) to remote viewing station 12, which may add these additional images in the panorama image (38, and/or 41).

The process of capturing images (by the camera), creating a panorama image, indicating required additional images (by the remote viewing station), capturing the required images, and sending the images to the remote viewing station (by the camera), and updating the panorama image with the required images (by the remote viewing station), may be repeated as needed. It is appreciated that this processes is performed substantially in real-time.

The embodiments as shown and described herein apply to several different scenarios. In a first scenario the local user is capturing inherently stable images such as one or more still images. In a second scenario the local user is capturing inherently unstable imaging such as a video stream.

In a third scenario, the remote user is watching the unstable image (e.g., video stream) in real-time, and the remote camera orientation system 10 is used to stabilize the picture by guiding the local user, in real-time, to orient the camera at a required point or area of interest as indicated by the remote user.

In a forth scenario the remote user is watching the captured images in near-real-time indicating one or more points or areas of interest for which images should be collected by the local user. The remote camera orientation system 10 then guides the local user accordingly.

In a fifth scenario the remote user is watching inherently unstable captured images in near-real-time, and the remote camera orientation system 10 stabilizes the image viewed by the remote user, for example by operating the panorama processing system and/or the remote resolution system enabling as disclosed herein. The remote camera orientation system 10 then enables the remote user to indicate one or more points or areas of interest, and then the remote camera orientation system 10 may guide the local user accordingly to orient the camera and capture the required images.

The term point of interest may refer to a particular point in the surrounding of the local user. The remote camera orientation system 10 may enable the remote user to indicate such point of interest using the remote viewing station. The remote camera orientation system 10 may then translate the point of interest into a particular orientation of the camera, and guide the local user accordingly.

The term area of interest may refer to a particular are in the surrounding of the local user. The remote camera orientation system 10 may enable the remote user to indicate such area of interest using the remote viewing station. In a scenario where the area of interest is smaller than the field of view of the camera the remote camera orientation system 10 may then translate the area of interest into a particular range of camera orientation, and guide the local user accordingly. For example, if the remote user is watching the captured video stream in real-time, the remote camera orientation system 10 may guide the local user to maintain the camera so that the area of interest is within the field captured by the camera.

If for example, the area of interest is larger than the field of view of the camera the remote camera orientation system 10 may guide the local user to scan the surrounding to capture the entire area of interest.

Remote camera orientation system 10 may enable the remote user to indicate a point and/or area of interest by pointing or marking a particular point or area on the screen of the remote viewing station.

It is appreciated that the scenarios disclosed are not limiting, and are provided as examples or possible use-cases of remote camera orientation system 10. Further scenarios and use-cases are contemplated even if not described explicitly.

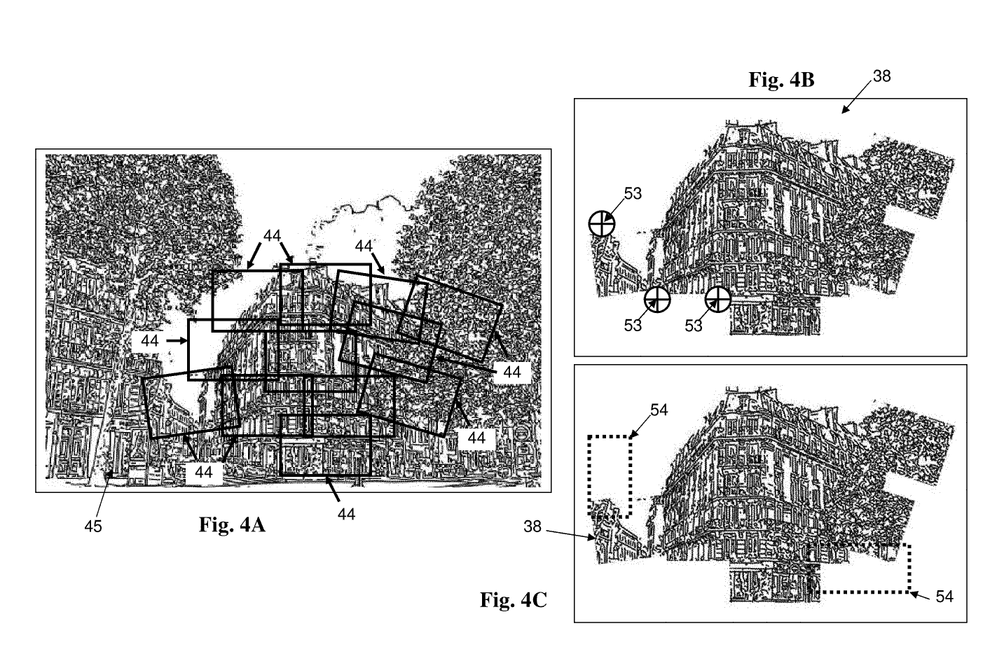

Reference is now made to FIG. 4A, FIG. 4B and FIG. 4C, which are simplified illustrations of a plurality of images 44 of an object, or view, 45, according to one exemplary embodiment.

As an option, the illustrations of FIGS. 4A, 4B and 4C may be viewed in the context of the details of the previous Figures. Of course, however, the illustration of FIGS. 4A, 4B and 4C may be viewed in the context of any desired environment. Further, the aforementioned definitions may equally apply to the description below.

FIG. 4A shows object 45 and a plurality of images 44 taken by a camera such as camera 11 of FIGS. 1 and 3. Images 44 may correspond to images 39 of FIG. 3 and may include capture data such as capture data 40. Images 44 may have been taken by a camera 11, or a plurality of cameras 11, possibly sweeping across object 45, creating a sequence of images 44. Images 44 may therefore be a sequence of still images, a sequence, or stream, of video frames, one or more stereo-pictures, 3D images, thermal images, etc., or combinations thereof. Images 44 may have been taken by rotating camera 11 or moving camera 11 or both. Therefore the orientation, or angle of the camera with respect to object 45 as well as the field of view of camera 11 and/or its distance from object 45 may change with every image.

Images 44 may be disconnected in the sense that images 44 may not include a shared object or overlapping area. Images 44 may be at least partly overlapping in the sense that at least two images 44 include the same object, or the same part of an object, or share an area of the surrounding, etc. It is appreciated that images 44 may be partly disconnected and partly overlapping in the sense that some images 44 may not have any shared object with any other images 44, while other images 44 may have at least one shared object with at least one another image 44. As shown in FIG. 4A, at least some images 44 are at least partly overlapping, thus enabling the creation of a panorama image.

FIG. 4B and FIG. 4C show a panorama image made from images 44 as may be displayed on a screen of a remote viewing station such as remote viewing station 12 of FIGS. 1 and 3.

Returning to the communication channel 36 of FIG. 3, it is appreciated that in a first phase of communication, camera 11 sends (or transmits) to viewing station 12 and/or imaging server 16 the plurality of images 44 in relatively low-resolution. Camera 11 may use remote orientation software 17 (or a part of remote orientation software 17) to send images 44 to viewing station 12 and/or imaging server 16.

The term resolution herein may refer to any aspect of the amount of information associated to any type of image. Such aspects may be, for example:
Spatial resolution, or granularity, represented, for example, as pixel density or the number of pixels per area unit (e.g., pixels per square inch or square centimeter).
Temporal resolution, represented, for example, the number of images per second, or as frame-rate.
Color resolution or color depth, or gray level, or intensity, or contrast, represented, for example, as the number of bits per pixel.
Compression level or type, including, for example, the amount of data loss due to compression. Data loss may represent any of the resolution types described herein, such as spatial, temporal and color resolution.
Any combination thereof.

One reason, for example, for sending images in low-resolution is a limitation on a communication parameter such as bandwidth (e.g., bits per second). Sending images 44 from camera 11 to be viewed in real-time, or near-real-time, by a user at viewing station 12 using network 13 having a limited bandwidth requires sending low-resolution version of images 44.

Therefore, while images 44 may be taken by camera 11 in relatively high-resolution (and stored therewith in high-resolution), camera 11 may convert the high-resolution images 44 into low-resolution images 44 and send the low-resolution images 44 to viewing station 12 and/or imaging server 16.

Converting an image from a high-resolution version or format into a low-resolution version or format may be executed in any manner know in the art such as by reducing the number of bits per pixel, reducing pixel density (e.g., the number of pixels per area), using a lossy compression, etc.

Thereafter, viewing station 12 and/or imaging server 16 combine at least two of the low-resolution images 44 into a panorama image, for example, in a two-stage process.

In the first stage images 44 may be positioned within the panorama space according to their respective capture data 40. This enables the positioning of images 44 which do not have an overlapping area or a shared object (disconnected images). Similarly, this stage enables the positioning of two or more groups of overlapping images, where the images in each group have overlapping areas or objects with at least one another image in that group, but no image in a first group has any overlapping area or object with any image of a second group (disconnected groups).

In the second stage, images within a group of overlapping images are accurately positioned using high-resolution image portions.

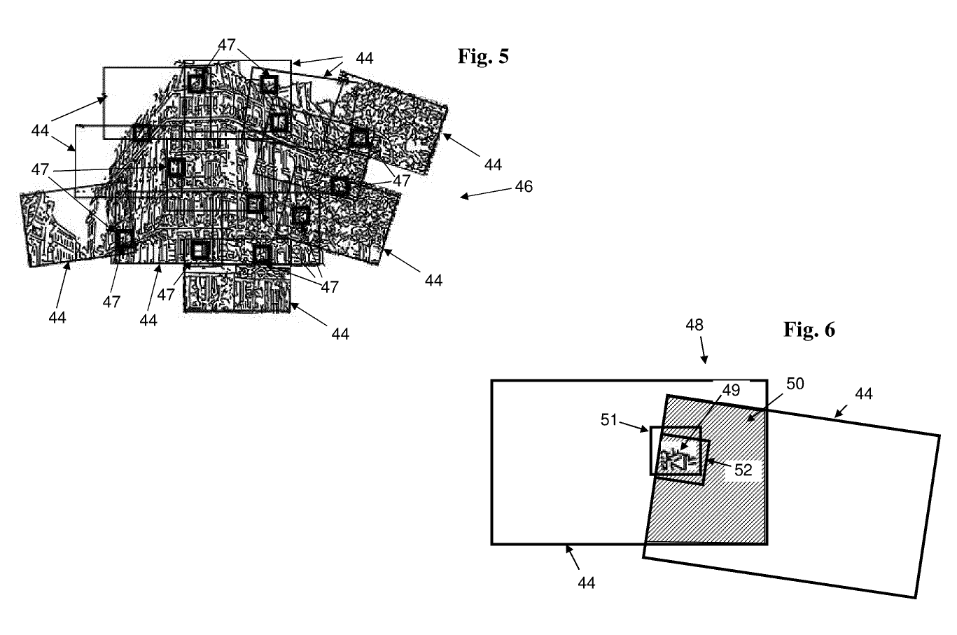

Reference is now made to FIG. 5, which is a simplified illustration of a panorama image 46, according to one exemplary embodiment.

As an option, panorama image 46 of FIG. 5 may be viewed in the context of the details of the previous Figures. Of course, however, the FIG. 5 may be viewed in the context of any desired environment. Further, the aforementioned definitions may equally apply to the description below.

As shown in FIG. 5, panorama image 46 includes a plurality of images 44 sent by camera 11 to viewing station 12 and/or imaging server 16, typically in the form of low-resolution images 44. Panorama image 46 may be created by viewing station 12 and/or imaging server 16 registering the low-resolution images 44 according to features or artifacts in their respectively overlapping areas. To register any two or more low-resolution images 44 sharing an overlapping area (or a feature or artifact therewith), viewing station 12 and/or imaging server 16 may use remote orientation software 17 (or a part of remote orientation software 17) to create panorama image 46.

For example, when registering two or more low-resolution images 44 according to features or artifacts in their respectively overlapping areas viewing station 12 and/or imaging server 16 may request camera 11 to send a high-resolution image of the particular features or artifacts or overlapping area share between the images 44 being registered.

As shown in FIG. 5, each image 44 includes one or more overlapping areas and within such overlapping area one or more artifacts. The term artifact may refer to any part or component of the photographed object (such as object 45 of FIG. 4A) that may serve to accurately register two or more images or an image of such part or component contained in two or more images 44. Image portions containing such artifacts are designated in FIG. 5 by numeral 47. It is appreciated that such image portion 47 is much smaller than its respective image 44, and thus the overall area of the image portions 47 of a panorama image 44 is much smaller than the total area of the panorama image 44.

Reference is now made to FIG. 6, which is a simplified illustration of a combined image 48 made of a plurality of images 44 having a shared feature 49, according to one exemplary embodiment.

As an option, the illustration of FIG. 6 may be viewed in the context of the details of the previous Figures. Of course, however, FIG. 6 may be viewed in the context of any desired environment. Further, the aforementioned definitions may equally apply to the description below.

It is appreciated that combined image 48 may represent a panorama image, or a part of panorama image, such as panorama image 38 of FIGS. 3 and 4B.

As shown in FIG. 6, combined image 48 includes two images 44, however, combined image 48 may include any number of images 44. Images 44 of combined image 48 have a shared or overlapping area 50. Overlapping area includes a feature, or artifact, or object 49 such as included or appearing in image portions 47 of panorama image 44 of FIG. 5 (termed shared artifact, or shared object).

It is appreciated that the two (or more) images 44 have been received by a viewing station (and/or by an imaging server) such as remote viewing station 12 (and/or imaging server 16) of FIGS. 1 and 3. Typically, images 44 have been received by a viewing station (and/or imaging server) in the form of low-resolution images. Viewing station (and/or by imaging server) may now assemble, or combine images 44 to create a combined image 48, or a panorama image.

To accurately register (e.g., combine, assemble) the two images 44 of combined image 48, the remote orientation software 17 (or part thereof in the viewing station 12 and/or imaging server 16) requests camera 11 (that is, the remote orientation software 17, or part thereof, in the camera 11) to send high-resolution (or higher-resolution) versions of respective image portions 51 and 52. As shown in FIG. 6, image portions 51 and 52 at least partially contain at least a part of shared or overlapping area 50 and/or the area designated as the image portion 47 in FIG. 5.

Image portions such as image portions 51 and 52 of FIG. 6 are accurately located in their respective high-resolution images 44. This term accurately located may mean that at least one feature of the image portion is associated with at least one feature of the respective image 44 in terms of high-resolution. A feature of the image portion and/or the image 44 may be, for example, the center of the image, or the high-left corner of the image, etc. Two or more such feature may be used, such as two opposing corners.

Accurately locating, or associating, in terms of high resolution may mean, for example, that the X, Y values of the feature of the image portion with respect to the feature of the images 44 are given as high-resolution pixel count. For example, the higher-left corner of the image portion is located N1 high-resolution pixels in the X dimension, and N2 high-resolution pixels in the Y dimension, from the higher-left corner of the respective images 44. This data accurately associating the location of an image portion with its respective image 44 is termed herein portion location data.

Remote camera-orientation system 10 enables a local camera 11 to obtain, or capture, images in high-resolution and communicate these images via a limited bandwidth network to a remote viewing station (or imaging server) as low-resolution images. The remote viewing station (or imaging server) may then combine two or more of these low-resolution images, in real-time, to create a panorama image. The remote viewing station (or imaging server) may register the low-resolution images accurately by requesting selected high-resolution image portions form camera 11. Each such high-resolution image portion (51 and 52 in FIG. 6) is accurately localized within its respective low-resolution image 44. As the image portions are of high-resolution the remote viewing station (or imaging server) may accurately register (orient) the low-resolution image 44 to form the combined image 48, and/or a panorama image 38.

Hence Remote camera-orientation system 10 may create an accurate image 48, and/or a panorama image 38 from low-resolution image 44. It is appreciated that image portion 51 may be a relatively small part of a respective first image 44. Therefore Remote camera-orientation system 10 may communicate an accurately registered panorama image via a limited bandwidth network by communicating a majority of the images 44 in low-resolution and only a small, selected, part of images 44 (namely, image portions such as image portions 51 and 52 of FIG. 6) in high-resolution.

In one embodiment, camera 11 divides one or more of images 44 into a plurality of image portions and the panorama assembly station (remote viewing station 12 and/or imaging server 16) may then select the image portion containing the desired artifact. In such situation camera 11 may send to the panorama assembly station a portion identifier for each of the image portions. The panorama assembly station may then determine the required image portion and sends to camera 11 the portion identifier associated with the required image portion. Camera 11 may then send to the panorama assembly station a high-resolution version of the image portion, along with the portion location data (in respective high-resolution units).

In another embodiment the panorama assembly station determines the location of the required artifact and sends to camera 11 a portion identifier defining the location of the artifact and the required area around it, thus defining an image portion. This portion identifier may include, for example, coordinates of a center point of the artifact and area around it, or coordinates of two opposing corners of a rectangle circumferencing the artifact, etc. The panorama assembly station may send to camera 11 the portion identifier data in terms (e.g., units) of low-resolution. Camera 11 then sends to the panorama assembly station a high-resolution version of the image portion, along with the portion location data in respective high-resolution units.

Returning to FIGS. 4B and 4C, remote viewing station 12 displays to user 15 a panorama image 38. It is appreciated that while FIGS. 4B and 4C show a contiguous image made of a group of images 44, the panorama image displayed by remote viewing station 12 may include two or more disconnected groups, and/or two or more disconnected images, and combinations thereof.

User 15 may then determine that there is a need for one or more particular images. As shown in FIGS. 4B and 4C, User 15 may determine that an image is required to add captured area at a particular edge of image 38. Alternatively, such needed image may be required to add area connecting between disconnected images, or between disconnected groups of images, or between a disconnected image and a group of images. Alternatively, such needed image may be required to add details in a particular area of image 38.

As shown in FIG. 4B, user 15 may indicate one or more particular points (point-of-interest) at which user 15 should direct local camera 11 to capture and communicate an additional image 44. User 15 may use a pointing device such as a mouse, or a touch screen, to make such indication. In this example, each indication requires a single image capture of the area surrounding the indication point 53.

As shown in FIG. 4C, user 15 may indicate one or more particular indication areas 54 at which user 15 should direct local camera 11 to capture and communicate one or more additional images 44. Indication area 54 may be larger than the area of a single image 44 and may therefore require a sequence of images 44, or a video steam, scanning the entire of area 54. Scanning indication area 54 may be accomplished by a plurality of at least partially overlapping images 44 to enable accurate registration of images 44. As shown in FIG. 4C, indication area 54 may designate or include at least one part of an already existing image 44 to enable the new images 44 to be accurately connected to, or associated with, the initial panorama image.

It is appreciated that indication points 53 and/or indication areas 54 may correspond to image capture indication data 42 of FIG. 3.

It is appreciated that user 15 may indicate one or more required images 44 using one or more indication points 53 and/or indication areas 54 and/or any combination of both indications, collectively termed indication data. It is appreciated that a point of interest indicated by indication data may reside inside an image or external to an image, where the image may be a one or more images and/or panorama images. Consequently the area designated by indication data may reside entirely within the image, partially external to the image, and entirely external to the image.

Once remote viewing station 12 received from user 15 indication data (53 and/or 54) of one or more missing images 44, remote viewing station 12 may guide user 14 to orient local camera 11 in the required direction to capture the missing image 44 and to communicate it to remote viewing station 12.

The process of adding the required or missing images 44 as determined and indicated by user 15 with one or more indication data 53 and/or 54 may be executed offline, or asynchronously, in the sense that user 15 may not be further involved in guiding user 14 to orient local camera 11 in the required direction to capture the missing image 44.

For example, when remote camera orientation system 10 is guiding user 14, user 15 may watch other parts of panorama image 38 and provide more indication data (e.g., one or more points and/or areas of interest). Therefore, remote camera orientation system 10 may receive new indication data from user 15 while remote camera orientation system 10 is guiding user 14 to capture images according to previously received indication data. In this sense, remote camera orientation system 10 may execute in parallel the process of receiving indication data from user 15, and the process of guiding user 14 to capture images according to previously received indication data.

Alternatively, user 15 may watch the process in which the required images 44 are being added to panorama image 38 and make additional indications 53 and/or 54. In this sense, the process of adding the required or missing images 44 as determined and indicated by user 15 with one or more indications 53 and/or 54 may be executed without direct communication between user 15 and user 14.

The process of guiding user 14 to orient local camera 11 in the required direction to capture the missing image 44 may be executed by remote camera orientation system 10 by providing user 14 with a set of cues indicating how to move local camera 11 to reach the required orientation for capturing the required (missing) image 44.

Returning to FIG. 3, in the process of adding the required or missing images 44, and/or guiding user 14 to orient local camera 11 in the required direction to capture the missing image 44, remote viewing station 12 may communicate one or more indication data 53 and/or 54 to local camera 11 (or to computing system 26 hosting, or associated with, local camera 11). Particularly, remote orientation software 17 (or a part thereof) executed by remote viewing station 12 may communicate one or more indication data 53 and/or 54 to remote orientation software 17 (or a part thereof) executed by local camera 11 (or computing system 26 hosting, or associated with, local camera 11).

Thereafter, remote orientation software 17 (or a part thereof) executed by local camera 11 (or computing system 26 hosting, or associated with, local camera 11) may guide user 14 to orient local camera 11 in the required direction and capture a required (missing) image 44 as indicated by user 15.

Local camera 11 (or computing system 26 hosting, or associated with, local camera 11) may guide user 14 by providing user 14 with sensory, or humanly perceptive, cues. Such cue may involve a visual cue, an auditory cue, a tactile or haptic cue, etc., as well as combinations thereof. For example, a cue may indicate to user 14 how, or where to move local camera 11, or to indicate how far is the current orientation of local camera 11 from the required orientation.

For example, local camera 11 (or computing system 26 hosting, or associated with, local camera 11) may produce an audible sound, such as an audio frequency, where the pitch (frequency) of the sound indicates the angle between the current orientation of local camera 11 and the required orientation. When user 14 moves local camera 11 so that the angle reduces the pitch is lowered, and when user 14 moves local camera 11 so that the angle increases the pitch increases (higher frequency). When user 14 orients local camera 11 at the required direction so that the angle is minimal the pitch is below the audible frequency and the user hears silence. This may typically cause user 14 to move local camera 11 in a spiral path towards the required orientation.

Alternatively, the cue may include a pulse of a particular pitch, and the repetition rate of the pulse may change (increase or decrease) with the angle between the current orientation of local camera 11 and the required orientation.

To have a two dimensional cue (e.g., left-right and up-down, or horizontal and vertical) the angle (between the current orientation of local camera 11 and the required orientation) in each dimension may be indicated by a different pitch. For example, one pitch of varying pulse repetition rate may indicate left-right angle while another pitch of varying pulse repetition rate may indicate up-down angle. Four pitches may be user to further difference between above and below in the vertical dimension and between too-left and too-right in the horizontal dimension.

Alternatively, pair of frequencies of varying pitch may indicate the angle in each dimension (e.g., horizontal and vertical) or quarter (e.g., left, right, up, down) where the each pair has a particular difference such as a tertian chord for a horizontal angle and quintal chord for a vertical angle.

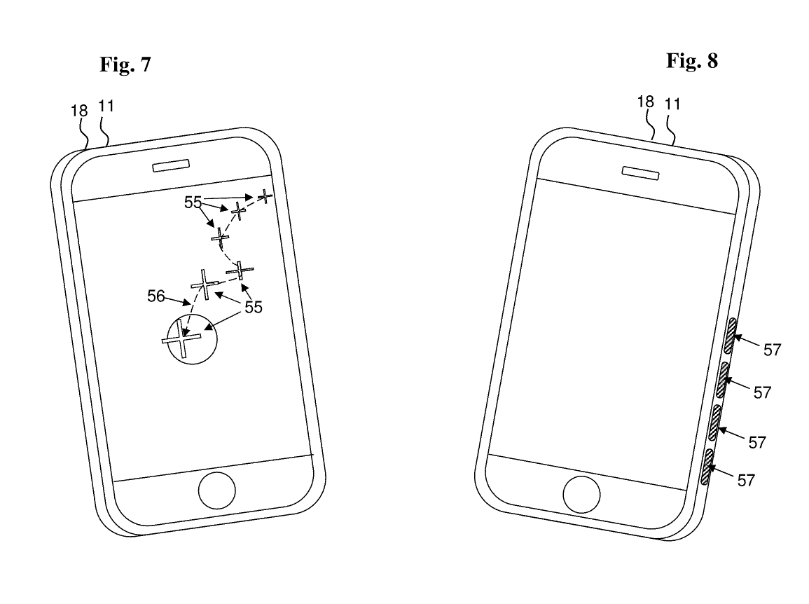

Reference is now made to FIG. 7, which is a simplified illustration of local camera 11 providing a visual cue 55, according to one exemplary embodiment.

As an option, the visual cue of FIG. 7 may be viewed in the context of the details of the previous Figures. Of course, however, the visual cue of FIG. 7 may be viewed in the context of any desired environment. Further, the aforementioned definitions may equally apply to the description below. For example, visual cue 55 may correspond to cue 43 of FIG. 3.

As shown in FIG. 7 visual cue 55 may be a cross-hair or a similar symbol, which may change its location on the screen, as well as its size and aspect ratio, according to the angle between the current orientation of local camera 11 and the required orientation. FIG. 7 shows several visual cues 55 as seen by user 14 as user 14 moves local camera 11 along a path 56 until local camera 11 is oriented at the required direction.

Alternatively, if user 14 cannot see details (such as a cross-hair) displayed on the screen of local camera 11, the display or a similar lighting element may be used in a manner similar to the acoustic cues described above, namely any combination of frequency (pitch, e.g. color) and pulse rate that may convey an estimate of the angle, or angles, between the current orientation of local camera 11 and the required orientation.

Reference is now made to FIG. 8, which is a simplified illustration of a local camera 11 providing a tactile cue, according to one exemplary embodiment.

As an option, FIG. 8 may be viewed in the context of the details of the previous Figures. Of course, however, FIG. 8 may be viewed in the context of any desired environment. Further, the aforementioned definitions may equally apply to the description below. For example, the tactile cue may correspond to cue 43 of FIG. 3.

As shown in FIG. 8, local camera 11 may have four tactile actuators 57, which may correspond to the position of four fingers holding local camera 11. Each tactile actuator 57 produces a sensory output that can be distinguished by the respective finger. A tactile actuator 57 may include a vibrating motor, a solenoid actuator, a piezoelectric actuator, a speaker, etc. The cue provided by tactile actuator 57 may indicate the direction (e.g., up, down, left, right) in which the local camera 11 should be rotated. For the pulse repetition rate of the tactile cue may represent the angle between the current orientation of local camera 11 and the required orientation.

It is appreciated that the tactile orientation, or cue, as disclosed above is not limiting and that other tactile mechanisms are contemplated. For example, a tactile sensory feeling may be provided to a user by vibrating, for example, the camera, or the smartphone, left/right/up/down. For example, vibration moving to the right may indicate the need to move the camera to the right.

Similarly, a sound map may indicate the required motion of the camera. For example, a sound moving from the left to right may indicate the need to move the camera to the right.

When user 14 orients of local camera 11 as required by the respective indication data (53, 54) local camera 11 may capture the required image automatically or manually. Thereafter, local camera 11, and/or the respective part of remote orientation software 17, may automatically proceed to the next indication data (53, 54).

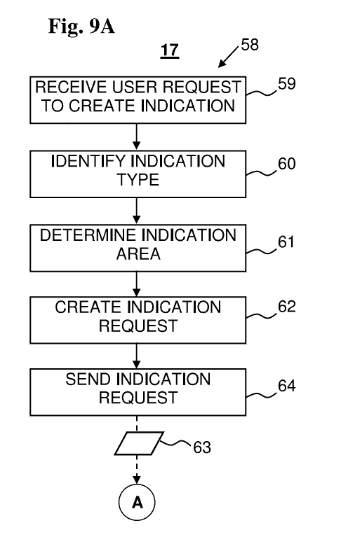

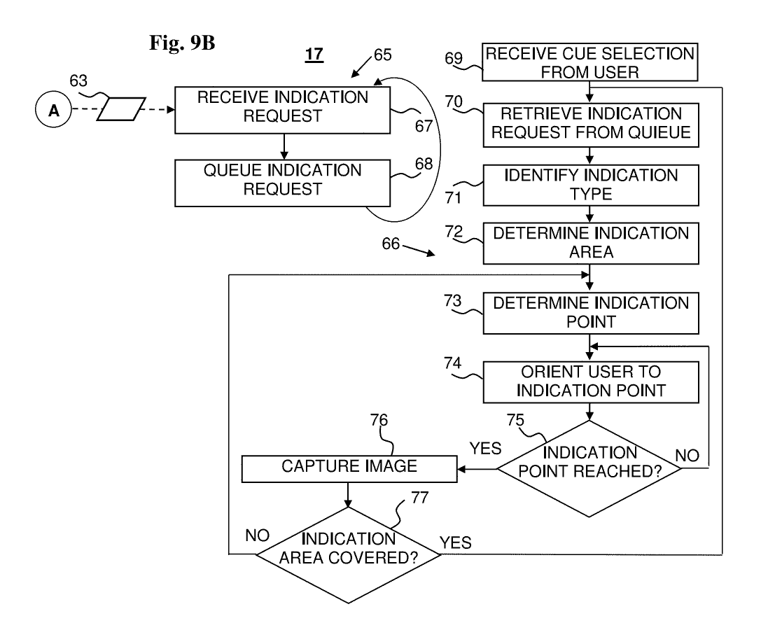

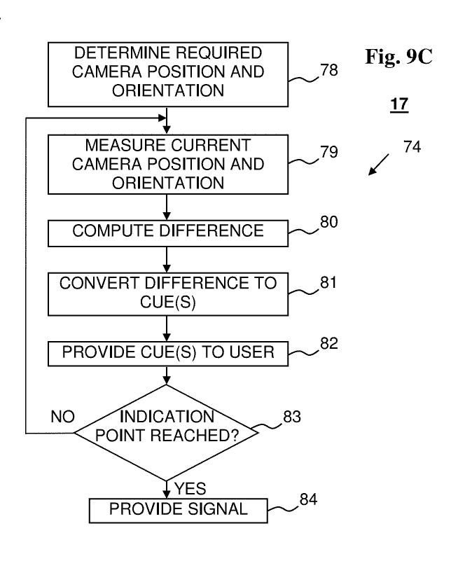

Reference is now made to FIG. 9A, FIG. 9B, and FIG. 9B, which, taken together, are a simplified flow-chart of remote orientation software 17, according to one exemplary embodiment.

As an option, the flow-chart of FIGS. 9A. 9B, and 9B may be viewed in the context of the details of the previous Figures. Of course, however, the flow-chart of FIGS. 9A. 9B, and 9B may be viewed in the context of any desired environment. Further, the aforementioned definitions may equally apply to the description below.

FIG. 9A shows a flow-chart of an indication creation process 58 of remote orientation software 17 that may be executed by remote viewing station 12. As shown in FIG. 9A, indication creation process 58 may start with step 59 by receiving from user 15 a request to create an indication for a missing image.

Indication creation process 58 may then proceed to step 60 to determine the type of indication, such as indication point (e.g., 53) or indication area (e.g., 54). Indication creation process 58 may then proceed to step 61 to determine the area surrounding the indication point or included within the borders of the indication area.

Indication creation process 58 may then proceed to step 62 to create an indication request 63 and to send it (step 64) to the local camera 11.

FIG. 9B shows a flow-chart of an indication reception process 65, and an camera orientation process 66, both being parts of remote orientation software 17 that may be executed by local camera 11 or a computing device hosting camera 11 such as a smartphone.

As shown in FIG. 9B, indication reception process 65 receives (step 67) indication requests 63 from remote viewing station 12 and/or indication creation process 58 and store or queue them in a memory or a storage (step 68).

As shown in FIG. 9B, camera orientation process 66 may start with step 69 by receiving from user 14 a selection of a type of cue (e.g., audible, visual, tactile, etc.). Camera orientation process 66 may then proceed to step 70 to retrieve am indication request from the queue into which indication reception process 65 has placed indication requests 63.

Camera orientation process 66 may then proceed to step 71 to identify the type of the indication request (e.g. indication point or indication area) and to step 72 to determine the image area required by the indication.

Camera orientation process 66 may then proceed to step 73 to determine an indication point where an image should be captured and to orient user 14 (step 74) until local camera 11 is directed at the required indication point (step 75). Camera orientation process 66 may capture the required image, or instruct user 14 to capture the image (step 76).

If the area indicated by the indication request 63 is not yet covered (step 77) camera orientation process 66 may create a new indication point (step 73) and repeat steps 74-76 until the entire area is covered. Camera orientation process 66 may create a successive indication points so that the images captured in step 76 have some overlapping area.

FIG. 9C shows step 74 in more details. As shown in FIG. 9C, in step 78 camera orientation process 66 may first determine the required position an orientation of local camera 11 as required to capture the missing (required) image. Camera orientation process 66 may then proceed to step 79 to measure the current position and orientation of local camera 11.

Camera orientation process 66 may then proceed to step 80 to compute the difference between the current camera position and orientation and the required position and orientation. The difference may be computed as an angle, or a pair of angles (e.g., Cartesian angles). A difference value (e.g., an angle value) may be provided as a linear value or a non-linear value (e.g., logarithmic). The difference may be provided as a set of optional values as may be used according to one or more of the selected cue.

Camera orientation process 66 may then proceed to step 81 to convert the difference into a cue according to the cue type selected by the user in step 69, and then to step 82 to provide the cue to user 14. Steps 78 to 82 may be repeated until camera 11 reaches the indication, for example, when the difference computed in step 64 reduces below a predetermined threshold (step 83).

When camera 11 reaches the indication point camera orientation process 66 may provide a signal (step 84) to invoke image capture. Such signal may be a cue provided to the user, or an electronic signal to camera 11 to trigger the image capture automatically. Alternatively, camera 11 may trigger the image capture by instructing the local user, for example, by using a humanly perceptive signal.

Therefore, for example, a possible scenario for two users using together remote camera orientation system 10 may involve the following actions:

A. Capturing one or more images by camera 11 operated by first user 14.

B. Communicating images captured by camera 11, over communication network 13 to remote viewing station 12 operated by a second, remote, user 15. The images may be communicated in low-resolution to comply with bandOwidth requirements.

C. Optionally combining images captured by camera 11 to form one or more panorama images. The panorama images may be based on the low-resolution images. However, high-resolution image-portions may be requested and received from camera 11 to enable accurate (e.g., high-resolution) registration (stitching) of the images to form an accurate panorama. The images and/or the panorama images are then presented to user 15.

D. Receiving from the second user (user 15) one or more indications of a point-of-interest (indication point), and/or an area of interest, associated with at least one of the images (and/or panorama images). These points of interest are then communicated to camera 11 or to a computing device associated with camera 11.

E. Converting each such point of interest into a measure of the required camera orientation.

F. Measuring the current orientation of camera 11 (forming current camera orientation), and computing the difference between the current camera orientation and the required camera orientation.

G. Converting the between the current camera orientation and the required camera orientation into a user-perceptive cue and providing the cue to the first user 14. The camera orientation cue may be audible, visual, tactile and/or verbal.

H. Repeating steps F-G until the difference between the current camera orientation and the required camera orientation reduces below a predefined threshold.

I. Triggering image capture by camera 11 either automatically, or by providing user 14 an appropriate cue of instruction. The image capture cue may be audible, visual, tactile or verbal.

J. Sending the captured image to the remote viewing station 12. The (newly) captured image may be captured in high-resolution and communicated to the remote viewing station 12 in low resolution.

K. Remote viewing station 12 may then (optionally) combine the newly captured image with previously received images and/or panorama images to form a panorama image, or to extend a panorama image, or to connect together two panorama images, etc. High-resolution image-portions of the newly captured image may be requested and received from camera 11 to enable accurate (e.g., high-resolution) registration (stitching) of the images to form an accurate panorama. The images and/or the panorama images are then presented to user 15.

L. This process (e.g., steps D to L) may be repeated. The process may be executed in real-time, however, asynchronously, in the sense that the remote user 15 may generate new points-of-interest, which are queued, while user 14 and camera 11 are capturing images of previously created points-of-interest. On the other side, remote camera orientation system 10 develops and make available to user 15 (via remote viewing station 12) the panorama images continuously as newly captured images are received from camera 11.

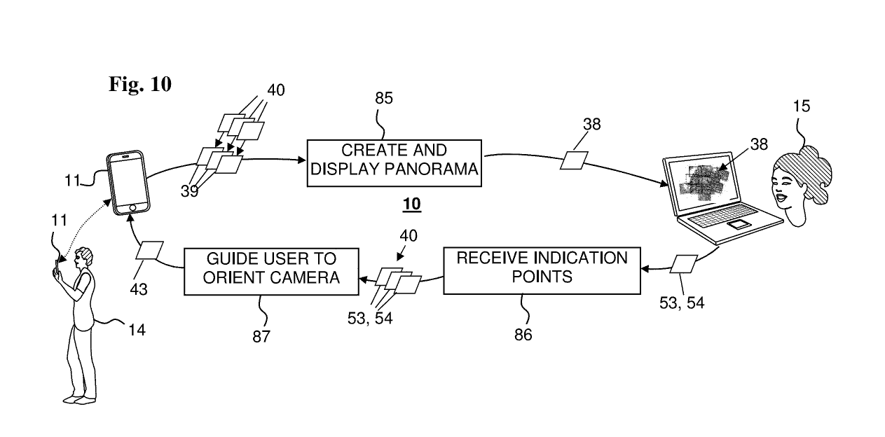

Reference is now made to FIG. 10, which is a simplified block diagram of remote camera orientation system 10, according to one exemplary embodiment.

As an option, the block diagram of remote camera orientation system 10 of FIG. 10 may be viewed in the context of the details of the previous Figures. Of course, however, block diagram of remote camera orientation system 10 of FIG. 10 may be viewed in the context of any desired environment. Further, the aforementioned definitions may equally apply to the description below.

As shown in FIG. 10, the process executed by remote camera orientation system 10 includes three main sub-processes:

A. Panorama process 85 receives images 39 and their capture data 40, and creates (one or more) panorama images 38.

B. Indication process 86 displays panorama images 38 and receives from user 15 one or more indication points 53 and/or indication areas 54 indicating one or more points of interest where user 15 requires more images.

C. Camera orientation process 87 may receive and queue one or more indication points 53 and/or indication areas 54, and then guides user 14 to orient camera 11 to capture the required images as indicated by each and every indication points 53 and/or indication areas 54, one by one. Camera orientation process 87 may then provide local user 14 with cues 43, guiding local user 14 to orient camera 11 in the direction require to capture the image as indicated by indication point 53 and/or indication area 54, and to capture the image.

It is appreciated that, when camera 11 is oriented as required, camera orientation process 87 may provide local user 14 with a special cue instructing local user 14 to capture an image. Alternatively, camera orientation process 87 may trigger the camera directly, or automatically, or autonomously.

It is appreciated that these three sub-processes 85, 86 and 87 may be executed in parallel. Therefore while camera orientation process 85 guides user 14 to capture new images 39, panorama process 86 generates, or expands or joins, panorama images 38 from previously captured images 39, and in the same time indication process 87 displays an image 39 and/or a panorama images 38 and receives from user 15 more indication points 53 and/or indication areas 54. In other words, receiving from user 15 an indication of a second point of interest while providing user 14 a cue with respect to a previously provided point of interest.

It is appreciated that sub-processes 85, 86 are optionally executed by remote viewing station 12 and sub-process 87 is optionally executed by camera 11, however, any of sub-processes 85, 86 and 87 may be at least partially executed by imaging server 16.

It is appreciated that the measure of difference between the current camera orientation and the required camera orientation may be computed as a planar angle, a solid angle, a pair of Cartesian angles, etc. The cure provided to the user may be audible, visual, tactile and verbal, or combinations thereof. A cue representing a two-dimensional value such as a solid angle, a pair of Cartesian angles, etc., may include two or more cues, each representing or associated with a particular dimension of the difference.

It is appreciated that the cue provided to user 14 may include a magnitude, or an amplitude, or a similar value, representing the difference between the current camera orientation and the required camera orientation in a linear manner or in a non-linear manner, such as a logarithmic value of the difference. Therefore, a small difference may be indicated more accurately than a large difference.

The magnitude of the cue may include amplitude and/or pitch, or frequency of an audible signal, or brightness of light, or color, or the position of a symbol such as cross-hair, etc., a pulsed signal where the pulse repetition rate represents the magnitude of the difference, etc., and combinations thereof.

A cue may include a combination of cues indicating a difference in two or three dimensions. For example, one cue indicating a horizontal difference and the other cue indicating a vertical difference.

A tactile signal may comprise four different tactile signals each representing a different difference value between the current camera orientation and the required camera orientation, for example, respectively associated with up, down, left and right differences.

Returning to FIG. 1, it is appreciated that a single remote user 15 may assist a plurality of local users 14. A single remote user 15 may assist a plurality of local users 14 in the same time, for example, by viewing the images provided by the plurality of local users 14 on different screens, or on different parts of a screen, or a combination thereof. It is appreciated that a single remote user 15 may indicate points of interest to local users 14 faster than the local users 14 can capture the required images. Therefore, a single remote user 15 may indicate a point of interest to a second local user 14 while the system is guiding a first local user 14 to capture the image of a previously provided point of interest. Such local users may be located in disparate locations or may located in the same location.

For example, considering a scenario where several local users are located close by, enabling the local users to capture images of substantially the same scenery from various directions (angles). Considering that for each of the local users, some of the scenery is blocked by objects between the local user and the scenery, it is useful and advantageous for the remote user to combine, into a single panorama image, images captured by two or more local users from their respective directions.

Therefore, remote camera orientation system 10 may enable the remote user 15 to indicate a particular point of interest, and (optionally) to select two or more local users 14. Remote camera orientation system 10 may then communicate the point of interest to the cameras (or associated computing device) of the selected local users 14. Each of these cameras (or associated computing device) may then guide the respective local user 14 to capture the image as indicated by the point of interest. Remote camera orientation system 10 may then communicate the captured images to the remote viewing station. The remote viewing station may then assemble an image combining elements from the plurality of images, captured from different directions, for the particular point of interest.

As disclosed above with reference to FIG. 1, remote viewing station 12 may be operated by, or implemented as, a computing machine, such as a server, which may be named herein imaging server 16. In this respect, remote viewing station 12 and/or imaging server 16 may execute artificial intelligence (AI) and/or machine learning (ML) and/or big-data (BD) technologies to assist remote user 15, or to replace remote user 15 for particular duties, or to replace remote user 15 entirely, for example, during late night time. Assisting or partly replacing remote user 15 may be useful, for example, when a remote user is assisting a plurality of local users 14. Therefore, the use of AI and/or ML and/or BD may improve the service provided to the local users 14 by offloading some of the duties of the remote user 15 and thus improving the response time.

Remote camera orientation system 10 may implement AI and/or ML and/or BD as one or more software programs, executed by one or more processors of the remote viewing station 12 and/or imaging server 16. This remote AI/ML/BD software program may learn how a remote user 15 may select and/or indicate a point and/or area of interest, such as indication points 53 of FIG. 4B, and/or indication areas 54 of FIG. 4C. In this respect, remote AI/ML/BD software programs may automatically identify typical sceneries, and may then automatically identify typical scenarios leading to typical indications of points of interest.

For example, the remote AI/ML/BD software program may learn to recognize a scenario such as walking up a hotel corridor, or a mall, or standing at a street crossing, or arriving at a bus stop. For example, in a hotel corridor, the remote AI/ML/BD software program may learn to recognize a door of a room, as well as the room number associated with the door. The remote AI/ML/BD software program may then automatically generate and send to the camera 11, or a computing device associated with the camera, a sequence indication of a point of interest. For example, the sequence may include a capturing forward look along the corridor, capturing a picture of a door aside, and then, based on the door image, capturing an image of the room number.

Similarly, standing at a street crossing, the sequence of indications of point of interest may include a first point of interest for capturing a forward look of the street crossing to identify the crossing lights post at the other side of the street crossing. Then a second point of interest for capturing the crossing lights post to identify the crossing signaling lights, and then a third point of interest for capturing the signaling lights.

Similarly, the remote camera orientation system 10 may automatically generate a sequence of indications of point of interests seeking an elevator door in a mall, or the bus number on a bus station sign.

It is appreciated that the remote AI/ML/BD software program may access a database of particular scenarios to identify the locality in which the local user is located and use sequences already prepared for the particular scenario. For example, if the particular hotel corridor was already traveled several times, even by different local users, possibly assisted by different remote users, an optimal sequence may have been created by the remote AI/ML software program. Thus, the remote AI/ML software program continuously improves the sequences used.

It is appreciated that in some cases the remote AI/ML/BD software program may be executed, entirely or partially, by the camera 11, or by a computing device associated with the camera, such as a smartphone.

Additionally or alternatively, remote camera orientation system 10 may implement AI and/or ML and/or BD as a software program, executed by a processor of camera 11, or a computing device associated with the camera, such as a smartphone. This local AI/ML/BD software program may learn the behavior of local user 14 and adapt the cueing mechanism to the particular local user 14. Particularly, local AI/ML/BD software program may learn how fast, and/or how accurate, a particular local user 14 responds to a particular type of cue. Local AI/ML/BD software program may then issue a corrective cue adaptive to the typical user response.

Therefore, remote camera orientation system 10 may record sessions in which a remote user assists a local user. Such session recording may include the images captured by the local user, the panorama images created by the remote viewing stations, and the points of interest indicated by the remote user. The session recording records the data (e.g., imaging data, indication points data, etc.) as well as the process by which the remote user guided the local user, the cueing means of preference by the particular local user as well as its adaptation to the particular locality, and the manner in which the local user responded to the guiding instructions.

Remote camera orientation system 10 may then analyze these databases using AI/ML/BD technologies and produce automatic processes for recognizing particular sceneries, recognizing particular scenarios, and automatically generating indication sequences that are optimal to the scenery, scenario, and particular local user.

It is appreciated that at least some parts of indication creation process 58, particularly when automated as described above with reference to AI/ML/BD, may be executed by the local camera 11 or by the computing device associated with camera 11. For example, local camera 11 (or the associated computing device) may automatically recognize the scenery, and/or recognize the scenario, and/or automatically generate indications to collect necessary images and send them to the remote user.

It is appreciated that such procedures, or rules, as generated by machine learning processes, may be downloaded to the local camera 11 (or the associated computing device) from time to time. Particularly, the local camera 11 (or the associated computing device) may download such processes, or rules, in real time, responsive to data collected from other sources. For example, a particular procedure, or rule-set, adapted to a particular location (scenery), may be downloaded on-demand according to geo-location data such as GSP data, cellular location, Wi-Fi hot-spot identification, etc. If more than one scenario applies to the particular location the local camera 11 (or the associated computing device) may present to the local user a menu of such available scenarios for the user to select.

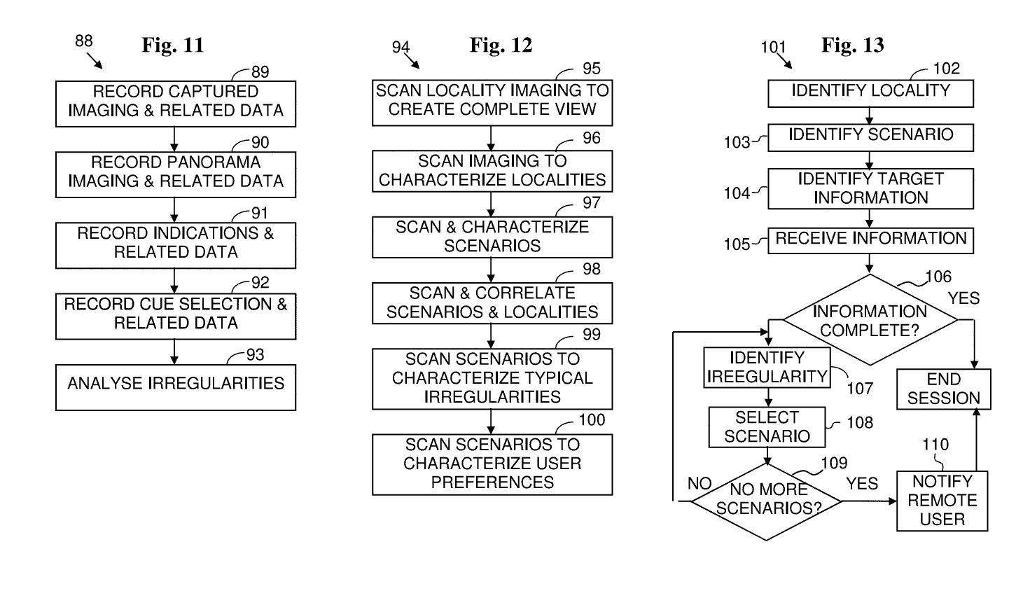

Reference is now made to FIG. 11, which is a simplified flow-chart of a session recording process 88, according to one exemplary embodiment.

As an option, the flow-chart of FIG. 11 may be viewed in the context of the details of the previous Figures. Of course, however, the flow-chart of FIG. 11 may be viewed in the context of any desired environment. Further, the aforementioned definitions may equally apply to the description below.

As shown in FIG. 11, session recording process 88 may start in step 89 by collecting captured images and related data such as geo-location (e.g., GPS data), camera orientation, time and date (time of day, day of the week, etc.), light conditions, etc. Captured images refer also to images captured responsive to indication of points of interest, and thus related data also refer to such indications of points of interest.

Session recording process 88 may then proceed to step 90 to record the panorama imaging and related data, such as the order in which the panorama image is assembled. Session recording process 88 may then proceed to step 91 to record the indications of point of interest and their related data, which may be the motivation of the remote user. The remote user may indicate, textually, verbally, or by selection from a menu, the reason for capturing the particular image. As the remote camera orientation system 10 characterizes sceneries and scenarios the session recording process 88 may make proper suggestions to the user and offer adequate menu selection.

Session recording process 88 may then proceed to step 92 to record the local user guiding process including the type of cue selected by the user, the user s responsiveness to the guiding process, etc. As the remote camera orientation system 10 characterizes sceneries and scenarios the session recording process 88 may then analyze (step 93) irregularities and deviation from a typical guiding process. Such irregularities may be then associated with the particular user, locality, ambient conditions, etc.

Reference is now made to FIG. 12, which is a simplified flow-chart of a data scanning process 94, according to one exemplary embodiment.

As an option, the flow-chart of FIG. 12 may be viewed in the context of the details of the previous Figures. Of course, however, flow-chart of FIG. 12 may be viewed in the context of any desired environment. Further, the aforementioned definitions may equally apply to the description below.

As shown in FIG. 12, data scanning process 94 may start in step 95 by scanning all images associated with each particular locality to create a comprehensive image of the locality so that later images of the locality (e.g., obtained in real-time) may be associated with older images. The term locality may refer to a hierarchical system of geo-locations as well as a system of location types.

Data scanning process 94 may then proceed to step 96 to imaging of various localities to create a database of sceneries, analyze location types and determine characterizing features associated with each location type so that a type of a location can be automatically identified base on a particular set of characterizing features. For example, identifying a hotel, identifying a lobby (of a hotel, or otherwise), identifying an elevators space (of a hotel, or otherwise), etc.

Data scanning process 94 may then proceed to step 97 to imaging of various guiding processes to create a database of scenarios, for example, based on the sequence of the points of interested selected by the remote user and their respective motivations as indicated by the remote user. Data scanning process 94 may then (step 98) scenarios and locations for example, according to their respective types and features proceed.

Data scanning process 94 may then proceed to step 99 to scan the scenarios by their type and location to identify irregularities and associate irregularities with locations, conditions, type of users, etc., and to characterized users preferences (step 100) regarding, for example, cue selection, and response time in particular sceneries, locations, conditions, etc.

Reference is now made to FIG. 13, which is a simplified flow-chart of an automatic guiding process 101, according to one exemplary embodiment.

As an option, the flow-chart of FIG. 13 may be viewed in the context of the details of the previous Figures. Of course, however, the flow-chart of FIG. 13 may be viewed in the context of any desired environment. Further, the aforementioned definitions may equally apply to the description below.

Automatic guiding process 101 is typically executed by remote camera orientation system 10 in real-time responsive to a local user requesting assistance from a remote viewing station or an imaging server 16. Automatic guiding process 101 provides automatic assistance to the local user based on information and rules collected, analyzed and created by session recording process 88 and data scanning process 94.

As shown in FIG. 13, automatic guiding process 101 may start in step 102 by identifying the scenery, or locality, hosting the local user. The scenery is identified by type and by identity (e.g., the particular location). Automatic guiding process 101 may request the local user to confirm the scenery identification.

Automatic guiding process 101 may then proceed to step 103 to identify the scenario. If there is a plurality of scenarios associated with the scenery as identified Automatic guiding process 101 may request the local user to select a scenario.

Automatic guiding process 101 may then proceed to step 104 to identify target information. If there is a plurality of target information items automatic guiding process 101 may request the local user to select a target information item. Such target information is associated with a particular image that the local user should capture using the local camera.

Automatic guiding process 101 may then proceed to step 105 to receive the target information. Step 105 may include guiding the local user to orient the local camera in a particular direction and capture the image containing the target information. Step may therefore include sending, from the remote viewing station or an imaging server, to the camera, or computing device associated with the camera, a sequence of one or more identifications of point of interest that eventually capture the image containing the targeted information.

Automatic guiding process 101 may then proceed to step 106 to determine if the target information has been obtained. If the selected scenario did not obtain the target information automatic guiding process 101 may then proceed to step 107 to determine the reason, for example by identifying a possible irregularity, and then proceed to step 108 to select an alternative scenario adaptive to the irregularity.

If no more scenarios are available (step 109) Automatic guiding process 101 may notify a remote user (step 110) to provide manual assistance to the local user.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for remotely guiding manual orientation of an imaging device, the method comprising:
a) capturing at least one image by an imaging device operated by a first user;
b) communicating said image to a remote station;
c) processing, in said remote station, an indication of at least one point of interest associated with said image;
d) communicating said point of interest to a computing device associated with said imaging device;
e) converting said point of interest into a measure of required orientation of said imaging device;
f) measuring current imaging device orientation to form current orientation;
g) computing difference between said current orientation and said required orientation;
h) converting said difference into a user-perceptive cue;
i) providing said cue to said first user;
j) repeating steps f to i until said difference reduces below a predefined threshold; and
k) triggering image capture by said imaging device.

2. The method according to claim 1, wherein said step of processing an indication additionally comprises:
receiving, by said remote station, from a second user operating said remote station, said indication of at least one point of interest.

3. The method according to claim 1, wherein said remote station comprises a software program to determine said point of interest.

4. The method according to claim 3, wherein said software program comprises at least one of artificial intelligence, big-data analysis, and machine learning, to determine said point of interest.

5. The method according to claim 4, wherein said at least one of artificial intelligence, big-data analysis, and machine learning, additionally comprises:
computing at least one correlation between said captured image and at least one of: a database of scenarios, and a database of scenarios; and at least one of:
determining said point of interest according to said at least one correlation;
determining at least one of target information and said point of interest according to at least one of first user preference and second user preference associated with a said at least one correlation; and
determining said cue according to a first user preference associated with said at least one correlation.

6. The method according to claim 1 wherein said step e is executed by said viewing station.

7. The method according to claim 1 wherein said difference is at least one of:
a measure of at least one of: a planar angle, a solid angle, and a pair of Cartesian angles; and
converted into said user-perceptive cue comprising a pair of cues each associated with one of said pair of Cartesian angles.

8. The method according to claim 1 wherein said cue comprises at least one of:
an audio signal, a visual signal, and a tactile signal;
at least one magnitude associated with said difference in at least one of a linear and a non-linear manner; and
a pulsed signal, wherein repetition rate of said pulsed signal is associated with said difference between said current orientation and said required orientation.

9. The method according to claim 8 additionally comprising at least one of:
wherein said magnitude comprises pitch of an audio signal; and.
wherein said tactile signal comprises four tactile signals respectively associated with up, down, left and right difference between said current orientation and said required orientation.

10. The method according to claim 1 further receiving from said second user an indication of at least one second point of interest while providing said cue to said first user with respect to a previously provided point of interest.

11. A system for remotely guiding manual orientation of an imaging device, the method comprising:
an imaging device operated by a first user and being configured to capture at least one image;
a communication device operative to receive said image from said imaging device and to communicate said image to a remote station configured to process an indication of at least one point of interest associated with said image, and to communicate said point of interest to a computing device associated with said imaging device;
said computing device being configured to guide said first user to orientate said imaging device according to said point of interest by performing the steps of:
a) converting said point of interest into a measure of required orientation;
b) measuring current imaging device orientation to form current orientation;
c) computing difference between said current orientation and said required orientation;
d) converting said difference into a user-perceptive cue;
e) providing said cue to said first user.
f) repeating steps b to e until said difference reduces below a predefined threshold; and
g) triggering image capture by said imaging device.

12. The system according to claim 11, wherein said remote station additionally comprises:
a user-interface module configured to receive from a second user operating said remote station said indication of at least one point of interest.

13. The system according to claim 11, wherein said remote station comprises a software program to determine said point of interest.

14. The system according to claim 13, wherein said software program comprises at least one of artificial intelligence, big-data analysis, and machine learning, to determine said point of interest.

15. The system according to claim 14, wherein said at least one of artificial intelligence, big-data analysis, and machine learning, additionally comprises computer code computing:
at least one correlation between said captured image and at least one of: a database of scenarios, and a database of scenarios; and at least one of:
said point of interest according to said at least one correlation;
at least one of target information and said point of interest according to at least one of first user preference and second user preference associated with a said at least one correlation; and
said cue type according to a first user preference associated with said at least one correlation.

16. The system according to claim 11, wherein at least one of said steps is executed by said viewing station.

17. The system according to claim 11, wherein said difference is at least one of:
a measure of at least one of: a planar angle, a solid angle, and a pair of Cartesian angles; and
converted into said user-perceptive cue comprising a pair of cues each associated with one of said pair of Cartesian angles.

18. The system according to claim 11, wherein said cue comprises at least one of:
an audio signal, a visual signal, and a tactile signal;
at least one magnitude associated with said difference in at least one of a linear and a non-linear manner; and
a pulsed signal, wherein repetition rate of said pulsed signal is associated with said difference between said current orientation and said required orientation.

19. The system according to claim 18 additionally comprising at least one of:
wherein said magnitude comprises pitch of an audio signal; and
wherein said tactile signal comprises four tactile signals respectively associated with up, down, left and right difference between said current orientation and said required orientation.

20. The system according to claim 11, further receiving from said second user an indication of at least one second point of interest while providing said cue to said first user with respect to a previously provided point of interest.

21. A computer program product embodied on a non-transitory computer readable medium, comprising computer code for:
a) capturing at least one image by an imaging device operated by a first user;
b) communicating said image to a remote station;
c) processing, in said remote station, an indication of at least one point of interest associated with said image;
d) communicating said point of interest to a computing device associated with said imaging device;
e) converting said point of interest into a measure of required orientation of said imaging device;
f) measuring current imaging device orientation to form current orientation;
g) computing difference between said current orientation and said required orientation;
h) converting said difference into a user-perceptive cue;
i) providing said cue to said first user;
j) repeating steps f to i until said difference reduces below a predefined threshold; and
k) triggering image capture by said imaging device.

22. The computer program product according to claim 21, wherein said processing an indication in said remote station additionally comprises:
receiving, by said remote station, from a second user operating said remote station, said indication of at least one point of interest.

23. The computer program product according to claim 21, additionally comprising at least one of artificial intelligence, big-data analysis, and machine learning, to determine said point of interest.

24. The computer program product according to claim 23, wherein said at least one of artificial intelligence, big-data analysis, and machine learning, additionally comprises computer code for:
computing at least one correlation between said captured image and at least one of: a database of scenarios, and a database of scenarios; and at least one of:
determining said point of interest according to said at least one correlation;
determining at least one of target information and said point of interest according to at least one of first user preference and second user preference associated with a said at least one correlation; and
determining said cue according to a first user preference associated with said at least one correlation.

25. The computer program product according to claim 21, wherein said step e is executed by said viewing station.

26. The computer program product according to claim 21, wherein said difference is at least one of:
a measure of at least one of: a planar angle, a solid angle, and a pair of Cartesian angles; and
converted into said user-perceptive cue comprising a pair of cues each associated with one of said pair of Cartesian angles.

27. The computer program product according to claim 21, wherein said cue comprises at least one of:
an audio signal, a visual signal, and a tactile signal:
at least one magnitude associated with said difference in at least one of a linear and a non-linear manner; and
a pulsed signal, wherein repetition rate of said pulsed signal is associated with said difference between said current orientation and said required orientation.

28. The computer program product according to claim 27, additionally comprising at least one of:
wherein said magnitude comprises pitch of an audio signal; and
wherein said tactile signal comprises four tactile signals respectively associated with up, down, left and right difference between said current orientation and said required orientation.

29. The computer program product according to claim 21 further receiving from said second user an indication of at least one second point of interest while providing said cue to said first user with respect to a previously provided point of interest.
